(19) United States
(12) Patent Application Publication
(10) Pub. No.: US 2023/0174408 A1
(43) Pub. Date: Jun. 8, 2023

(54) OPTICAL FIBER ECCENTRIC MEASUREMENT METHOD AND OPTICAL FIBER MANUFACTURING METHOD

(71) Applicant: SUMITOMO ELECTRIC INDUSTRIES, LTD., Osaka (JP)

(72) Inventors: Takahiro NOMURA, Osaka (JP); Kazuyuki SOHMA, Osaka (JP)

(73) Assignee: SUMITOMO ELECTRIC INDUSTRIES, LTD., Osaka (JP)

(21) Appl. No.: 18/076,442

(22) Filed: Dec. 7, 2022

(30) Foreign Application Priority Data
Dec. 8, 2021 (JP) 2021-199399

(51) Int. Cl. C03B 37/07; C03C 25/105; C03B 37/012

(52) U.S. Cl. CPC C03B 37/07; C03C 25/105; C03B 37/01205

(57) ABSTRACT

An eccentric state determining method which is performed by a controller and for determining a state of eccentricity of a coating of a glass fiber with respect to the glass fiber. The coating is formed around the glass fiber. The method includes acquiring measurement values for an outer diameter of the optical fiber at positions along a longitudinal direction of the optical fiber, calculating a standard deviation of the measurement values, and determining the state of the eccentricity based on the standard deviation.

### CROSS-REFERENCE TO RELATED APPLICATIONS

This application claims priority based on Japanese Patent Application No. 2021-199399 filed on Dec. 8, 2021, the entire contents of which are incorporated herein by reference.

### BACKGROUND

The present disclosure relates to an optical fiber eccentric state determining method and an optical fiber manufacturing method.

JPH04-319642A discloses an eccentricity measurement method for measuring eccentricity of a resin portion formed around a glass portion of an optical fiber.

In this eccentricity measurement method, a degree of eccentricity of the resin portion is detected by irradiating the optical fiber with a laser beam and analyzing a pattern of scattered light.

In a small-diameter optical fiber, since a thickness of a coating formed around a glass fiber is thin, it is difficult to measure eccentricity of the coating with respect to the glass fiber by analyzing a pattern of scattered light of a laser beam as described above.

### SUMMARY

According to an aspect of the disclosure, an eccentric state determining method performed by a controller for determining a state of eccentricity of a coating of a glass fiber with respect to the glass fiber, includes:

acquiring measurement values for an outer diameter of the optical fiber at positions along a longitudinal direction of the optical fiber;

calculating a standard deviation of the measurement values; and

determining the state of the eccentricity based on the standard deviation.

According to another aspect of the disclosure, an optical fiber manufacturing method for manufacturing an optical fiber by forming a glass fiber by heating and melting an optical fiber preform, and drawing the optical fiber preform and forming a coating around the glass fiber with a resin coating unit, includes:

measuring an outer diameter of the optical fiber at given time intervals during the manufacturing of the optical fiber to acquire measurement values for the outer diameter;

calculating a standard deviation of the measurement values; and

tilting the resin coating unit based on the standard deviation.

### BRIEF DESCRIPTION OF DRAWINGS

FIG. 1 is a schematic diagram illustrating a configuration of an optical fiber manufacturing apparatus according to the present embodiment.

FIG. 2 is a flowchart illustrating a flow of an optical fiber eccentric state determining method.

FIG. 3 is a flowchart illustrating another example of the flow of the optical fiber eccentric state determining method.

FIG. 4 is a flowchart illustrating a flow of an optical fiber manufacturing method.

FIG. 5 shows a relationship between a standard deviation σ and an eccentric amount maximum value.

FIG. 6 is a flowchart illustrating a flow of processing performed in STEP 24 in a case where processing from STEP 21 to STEP 24 in FIG. 4 is repeated.

FIG. 7 is a flowchart illustrating another example of the flow of the optical fiber manufacturing method.

FIG. 8 is a flowchart illustrating a flow of processing performed in STEP 36 in a case where processing from STEP 33 to STEP 37 in FIG. 7 is repeated.

### DESCRIPTION OF EMBODIMENTS

(Description of Embodiments of Present Disclosure)

First, aspects of the present disclosure will be listed and described.

(1) An optical fiber eccentric state determining method according to the present disclosure is a method performed by a control unit for determining, in an optical fiber including a glass fiber and a coating formed around the glass fiber, a state of eccentricity of the coating with respect to the glass fiber, and the method includes:
an acquisition step of acquiring measurement values for an outer diameter of the optical fiber at a plurality of positions along a longitudinal direction of the optical fiber;
a calculation step of calculating a standard deviation based on the plurality of measurement values for the outer diameter of the optical fiber; and
a determination step of determining the state of eccentricity of the coating based on the standard deviation.

According to the above method, the state of eccentricity of the coating with respect to the glass fiber (hereinafter, referred to as the eccentricity of the coating or simply referred to as the eccentricity) is determined based on the standard deviation of the outer diameter of the optical fiber.

Therefore, the state of eccentricity may be determined regardless of a thickness of the coating, as compared with a method for measuring the state of eccentricity of the coating by irradiating the coating with a laser beam, for example. Therefore, even in a case where the coating of the optical fiber is thin, the state of eccentricity of the coating with respect to the glass fiber may be determined.

(2) In the determination step, it may be determined that the eccentricity of the coating exceeds an allowable range in a case where the standard deviation is equal to or greater than a threshold.

According to the above method, the eccentric state of the coating is easily determined.

(3) In the acquisition step, measurement values for the outer diameter of the optical fiber measured at given time intervals during manufacture of the optical fiber may be acquired,

in the calculation step, a first standard deviation may be calculated based on a plurality of measurement values for the outer diameter of the optical fiber measured in a first period, and a second standard deviation may be calculated based on a plurality of measurement values for the outer diameter of the optical fiber measured in a second period after the first period, and

in the determination step, the state of eccentricity may be determined based on a comparison between the first standard deviation and the second standard deviation.

According to the above method, the state of eccentricity is determined by comparing the two standard deviations. Thus, the eccentric state is determined simply using the standard deviation without comparing the standard deviation with the threshold. For example, in a case where the state of eccentricity changes as time elapses from the start of manufacturing the optical fiber (for example, in a case where the state of eccentricity changes due to a change in positional relationship between the glass fiber and an optical fiber manufacturing apparatus), the change in state of eccentricity may be determined by comparing the two standard deviations.

The expression “the second period after the first period” used in the present specification includes not only a case in which the second period starts after the first period elapses but also a case in which the second period starts during the first period after the first period starts.

(4) In the determination step in (3), it may be determined that the eccentricity increases in a case where the second standard deviation is larger than the first standard deviation.

According to the above method, the increase in eccentricity is determined based on the increase in standard deviation. Therefore, in a case where the standard deviation increases, measures for reducing the eccentricity in the manufacture of the optical fiber is taken.

(5) An optical fiber manufacturing method for manufacturing an optical fiber by forming a glass fiber by heating and melting an optical fiber preform and drawing the optical fiber preform, and forming a coating around the glass fiber by a resin coating unit, includes:

a measurement step of measuring an outer diameter of the optical fiber at given time intervals during manufacture of the optical fiber;

a calculation step of calculating a standard deviation based on the plurality of measurement values for the outer diameter of the optical fiber; and

a step of tilting the resin coating unit based on the standard deviation.

According to the above method, the tilt of the resin coating unit is changed based on the standard deviation of the outer diameter of the optical fiber. Accordingly, the eccentricity of the coating is adjusted according to the state of eccentricity of the coating regardless of the thickness of the coating. Therefore, even in a case where the coating of the optical fiber is thin, the eccentricity of the coating is adjusted based on the state of eccentricity of the coating with respect to the glass fiber.

(6) In the step of tilting the resin coating unit, the resin coating unit may be tilted in a case where the standard deviation is equal to or greater than a threshold.

According to the above method, in a case where the standard deviation is equal to or greater than the threshold, the resin coating unit is tilted. Thus, in a case where the eccentricity exceeds an allowable range, the eccentricity is adjusted to decrease.

(7) In the calculation step, a first standard deviation may be calculated based on a plurality of measurement values for the outer diameter of the optical fiber measured in a first period, and a second standard deviation may be calculated based on a plurality of measurement values for the outer diameter of the optical fiber measured in a second period after the first period, and

in the step of tilting the resin coating unit, the resin coating unit may be tilted in a case where the second standard deviation is larger than the first standard deviation.

According to the above method, the eccentricity is adjusted by tilting the resin coating unit by comparing the two standard deviations instead of comparing the standard deviation with the threshold. In a case where the standard deviation increases with time, the resin coating unit is tilted. The eccentricity is adjusted so as to decrease the eccentricity.

(8) In the step of tilting the resin coating unit, in a case where a standard deviation calculated based on a plurality of measurement values for the outer diameter of the optical fiber including at least one measurement value measured after the resin coating unit is tilted is larger than a standard deviation calculated based on a plurality of measurement values for the outer diameter of the optical fiber measured before the resin coating unit is tilted, the resin coating unit may be tilted in a direction different from that of a previous tilt.

According to the above method, the eccentricity is adjusted so as to decrease the standard deviation, that is, the eccentricity by changing the tilt direction of the resin coating unit in a case where the standard deviation increases due to the tilt of the resin coating unit.

According to the present disclosure, even in a case where the coating of the optical fiber is thin, the state of eccentricity of the coating with respect to the glass fiber is determined.

[Details of Embodiments of the Present Disclosure]

Examples of embodiments of an optical fiber eccentric state determining method and an optical fiber manufacturing method according to the present disclosure will be described with reference to the drawings. The present invention is not limited to these examples but indicated by the scope of claims, and is intended to include meanings equivalent to the scope of claims and all modifications within the scope.

(Optical Fiber Manufacturing Apparatus)

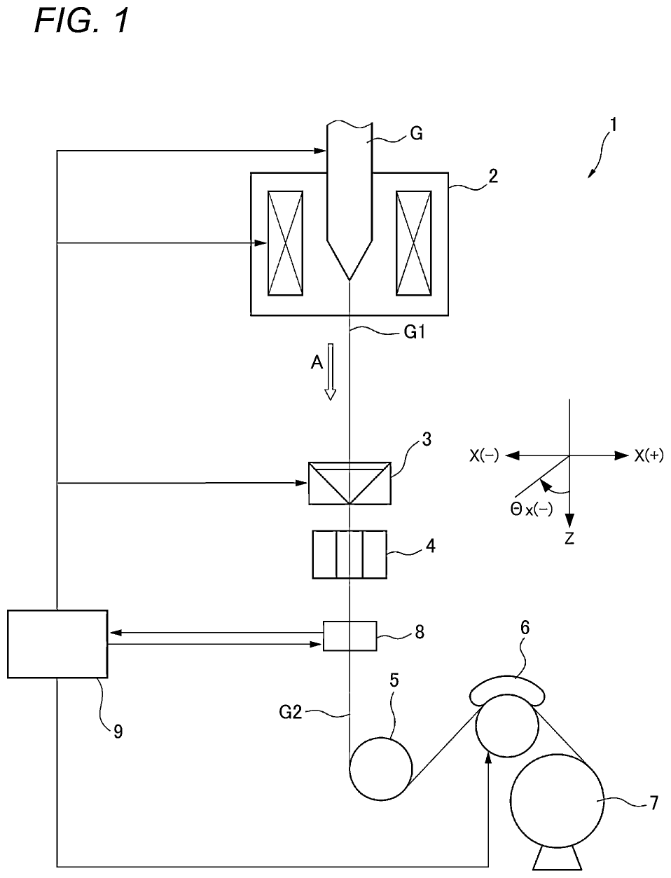

FIG. 1 is a schematic diagram illustrating a configuration of an optical fiber manufacturing apparatus 1 according to the present embodiment. The optical fiber manufacturing apparatus 1 is configured to manufacture an optical fiber G2 by forming a glass fiber G1 by heating and melting an optical fiber preform G, and drawing the optical fiber preform G; and forming a resin coating on an outer periphery of the glass fiber G1.

The optical fiber manufacturing apparatus 1 includes a heating furnace 2, a resin coating unit 3, a resin curing unit 4, a guide roller 5, a take-up unit 6, a winding drum 7, an outer diameter measurement unit 8, and a control unit 9.

The heating furnace 2 is configured to heat and soften a lower end portion of the optical fiber preform G. The lower end portion of the optical fiber preform G softened by heating is thinly stretched downward to form the glass fiber G1.

The resin coating unit 3 is disposed downstream the heating furnace 2 in a traveling direction of the glass fiber G1 (a direction indicated by an arrow A in FIG. 1). The resin coating unit 3 is configured to apply resin around the glass fiber G1.

The resin curing unit 4 is disposed downstream the resin coating unit 3 in the traveling direction of the glass fiber G1. The resin curing unit 4 is configured to cure the resin applied around the glass fiber G1. By curing the resin around the glass fiber G1, the optical fiber G2 in which a resin coating is formed around the glass fiber G1 is formed.

The guide roller 5, the take-up unit 6, and the winding drum 7 are disposed downstream the resin curing unit 4 in a traveling direction of the optical fiber G2. The optical fiber G2 is wound around the winding drum 7 via the guide roller 5 and the take-up unit 6.

The outer diameter measurement unit 8 is disposed between the resin curing unit 4 and the guide roller 5. The outer diameter measurement unit 8 measures an outer diameter of the optical fiber G2 using, for example, laser light. The outer diameter of the optical fiber G2 is measured in a given direction on a plane orthogonal to an axis of the optical fiber G2.

The control unit 9 is electrically connected to the heating furnace 2, the take-up unit 6, the outer diameter measurement unit 8, and the like, and is configured to control operations of these devices. The control unit 9 is configured to acquire measurement values for the outer diameter of the optical fiber G2 from the outer diameter measurement unit 8, calculate a standard deviation based on the acquired measurement values, and determine a state of eccentricity of the coating of the optical fiber G2 with respect to the glass fiber G1. Further, the control unit 9 is configured to adjust the eccentricity by controlling a tilt of the resin coating unit 3 based on the calculated standard deviation.

(Optical Fiber Eccentric State Determining Method)

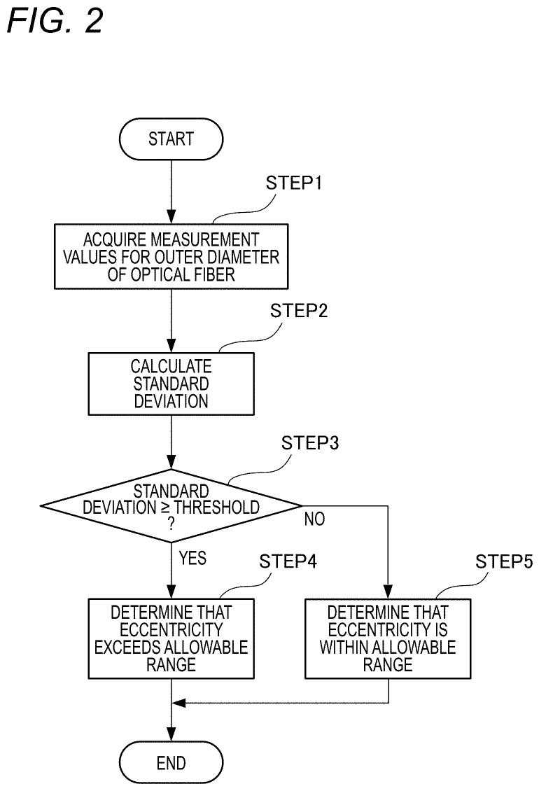

FIG. 2 illustrates a flow of a method for determining an eccentric state of the optical fiber G2 to be executed by the control unit 9.

First, the control unit 9 acquires measurement values for the outer diameter of the optical fiber G2 at a plurality of positions along a longitudinal direction of the optical fiber G2 (STEP 1). Specifically, the outer diameter measurement unit 8 measures the outer diameter of the optical fiber G2 traveling downstream from the resin curing unit 4 during manufacture (drawing) of the optical fiber G2 at given time intervals. The control unit 9 acquires, from the outer diameter measurement unit 8, measurement values for the outer diameter of the optical fiber G2 measured at given time intervals during the manufacture of the optical fiber G2.

Subsequently, the control unit 9 calculates a standard deviation σ based on the plurality of measurement values for the outer diameter of the optical fiber G2 (STEP 2). Specifically, the control unit 9 calculates the standard deviation σ based on the plurality of measurement values for the outer diameter of the optical fiber measured at given time intervals. For example, the standard deviation σ is expressed by the following Equation 1.

$$σ = \sqrt{\frac{1}{n} {\sum }_{i = 1}^{n} ( {X}_{i} - \overline{X} )} \qquad [ Equation 1 ]$$

n is the number of measurement values, X is the measurement value for the outer diameter, and X̅ is an average value of the measurement values for the outer diameter.

Subsequently, the control unit 9 determines the state of eccentricity of the coating based on the standard deviation σ. Specifically, the control unit 9 determines whether the standard deviation σ is equal to or greater than a threshold (STEP 3). The threshold is appropriately set according to individual differences of the optical fiber manufacturing apparatus 1 (in particular, the resin coating unit 3).

Then, in a case where it is determined that the standard deviation σ is equal to or greater than the threshold (YES in STEP 3), the control unit 9 determines that the eccentricity of the coating exceeds an allowable range (STEP 4). On the other hand, in a case where it is determined that the standard deviation σ is less than the threshold (NO in STEP 3), the control unit 9 determines that the eccentricity of the coating does not exceed the allowable range (STEP 5).

In a case where a center of the coating is deviated from a center of the glass fiber (that is, the coating is eccentric with respect to the glass fiber), the following problem occurs. For example, the loss (macro bend loss) increases when the optical fiber is bent. In general, when an optical fiber is bent, the loss occurs, but the loss in an eccentric optical fiber is larger than that in an uneccentric optical fiber. Further, in the eccentric optical fiber, a core of the glass fiber is deviated in a radial direction from the center of the optical fiber. Accordingly, in a case where the eccentric optical fiber is connected to another optical fiber, a positional deviation occurs between the core of the glass fiber of the eccentric optical fiber and a core of a glass fiber of an optical fiber that is a connection counterpart, and a signal is not sufficiently transmitted. In addition, a thickness of the coating of the eccentric optical fiber is not uniform, which may cause disconnection. In particular, in a small-diameter optical fiber having an outer diameter of 200 μm to 160 μm, a thickness of the coating formed around the glass fiber is small. Therefore, in a case where the center of the coating is deviated from the center of the glass fiber, the coating is likely to be thinned, and when the coating comes into contact with another member at a portion where the coating is thinned and is subjected to external damage, disconnection is likely to occur.

Therefore, it is required to manufacture an optical fiber in which the eccentricity of the coating does not exceed an allowable range. For example, it is conceivable to measure the eccentricity of the coating with respect to the glass fiber by analyzing a pattern of scattered light of a laser beam, but it is difficult to measure the eccentricity of a small-diameter optical fiber.

Therefore, the present inventors have found that there is a correlation between the standard deviation σ of the outer diameter of the optical fiber G2 and the eccentricity of the coating. That is, the inventors have found that the state of eccentricity of the coating may be determined based on the standard deviation σ of the outer diameter of the optical fiber G2.

Based on this finding, as described above, in the optical fiber eccentric state determining method according to the present embodiment, the state of eccentricity of the coating is determined based on the standard deviation σ. Therefore, a state in which the center of the coating is deviated from the center of the glass fiber G1 (that is, the coating is eccentric with respect to the glass fiber G1) may be grasped. Therefore, the state of eccentricity may be determined regardless of a thickness of the coating, as compared with a method for measuring the state of eccentricity of the coating by irradiating the coating with a laser beam, for example. That is, even in a case where the coating of the optical fiber G2 is thin, the state of eccentricity of the coating with respect to the glass fiber G1 may be determined. In addition, in the present embodiment, since the standard deviation σ is compared with the threshold, the eccentric state of the coating may be easily determined.

In the present embodiment, the state of eccentricity of the coating is determined based on the comparison between the standard deviation σ and the threshold. However, instead of the comparison between the standard deviation σ and the threshold, the eccentric state of the coating may be determined by comparing a plurality of standard deviations σ calculated based on measurement values measured in different periods.

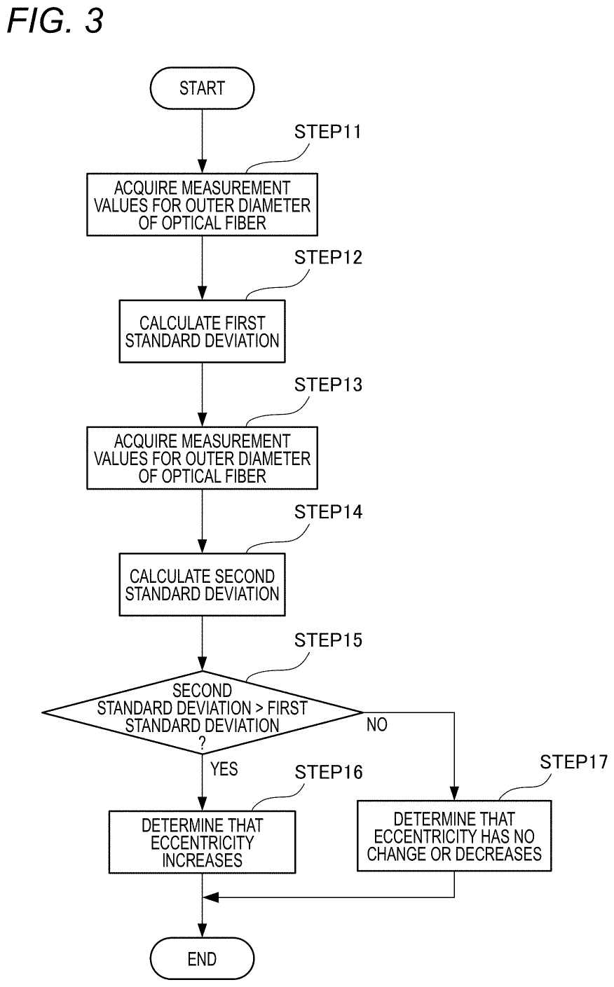

FIG. 3 illustrates another example of the flow of the method for determining the eccentric state of the optical fiber G2 to be executed by the control unit 9.

First, the control unit 9 acquires a plurality of measurement values for the outer diameter of the optical fiber G2 measured in a first period T1 during the manufacture of the optical fiber G2 (STEP 11). Then, the control unit 9 calculates a first standard deviation σ1 based on the plurality of measurement values for the outer diameter of the optical fiber G2 measured in the first period T1 (STEP 12).

Subsequently, the control unit 9 acquires a plurality of measurement values for the outer diameter of the optical fiber G2 measured in a second period T2 after the first period T1 has elapsed (STEP 13). Then, the control unit 9 calculates a second standard deviation σ2 based on the plurality of measurement values for the outer diameter of the optical fiber G2 measured in the second period T2 (STEP 14).

Subsequently, the control unit 9 determines the state of eccentricity based on a comparison between the first standard deviation σ1 and the second standard deviation σ2. Specifically, the control unit 9 determines whether the second standard deviation σ2 is larger than the first standard deviation σ1 (STEP 15).

Then, in a case where it is determined that the second standard deviation σ2 is larger than the first standard deviation σ1 (YES in STEP 15), the control unit 9 determines that the eccentricity of the coating gradually increases during the manufacture of the optical fiber G2 (STEP 16). On the other hand, in a case where it is determined that the second standard deviation σ2 is equal to or smaller than the first standard deviation σ1 (NO in STEP 15), the control unit 9 determines that the eccentricity of the coating does not change or gradually decreases (STEP 17).

According to such an eccentric state determining method, the state of eccentricity is determined by comparing the two standard deviations σ1 and σ2. Thus, the eccentric state may be determined simply using the standard deviation σ without comparing the standard deviation σ with the threshold. For example, in a case where the state of eccentricity changes as time elapses from the start of manufacturing the optical fiber G2 (for example, in a case where the state of eccentricity changes due to a change in positional relationship between the glass fiber G1 and the optical fiber manufacturing apparatus 1), the change in state of eccentricity may be determined by comparing the two standard deviations σ1 and σ2. In addition, in the embodiment, since the increase in eccentricity is determined based on the increase in standard deviation (σ2>σ1), in a case where the standard deviation increases, measures for reducing the eccentricity such as adjusting the eccentricity in the manufacture of the optical fiber may be taken.

In the present embodiment, the second standard deviation σ2 is calculated based on a plurality of measurement values measured in the second period T2 that starts after the first period T1 has elapsed. However, the second standard deviation σ2 may be calculated based on a plurality of measurement values measured in the second period T2 that starts during the first period T1 after the start of the first period T1. That is, the measurement values used for the second standard deviation σ2 may partially overlap the measurement values used for the first standard deviation σ1.

(Optical Fiber Manufacturing Method Using Eccentric State Determining Method)

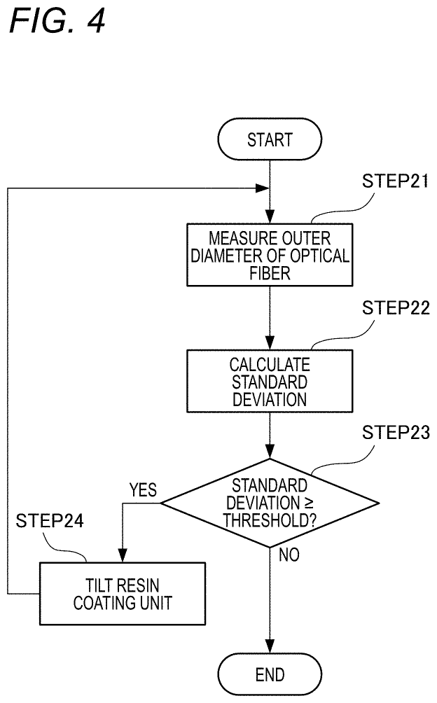

Next, a method for manufacturing the optical fiber G2 using the eccentric state determining method will be described with reference to FIG. 4. FIG. 4 illustrates a flow of the method for manufacturing the optical fiber G2. Detailed descriptions of the same steps as those of the eccentric state determining method of FIG. 2 will be omitted.

First, the resin coating is cured by the resin curing unit 4, and the outer diameter of the optical fiber G2 traveling downstream from the resin curing unit 4 is measured by the outer diameter measurement unit 8 at given time intervals (STEP 21). A plurality of measurement values for the outer diameter of the optical fiber G2 are output from the outer diameter measurement unit 8 to the control unit 9.

Subsequently, the control unit 9 calculates the standard deviation σ based on a plurality of measurement values for the outer diameter of the optical fiber G2 (STEP 22).

Subsequently, a tilt of the resin coating unit 3 is controlled based on the standard deviation σ. Specifically, the control unit 9 determines whether the standard deviation σ is equal to or greater than the threshold (STEP 23). Then, in a case where the control unit 9 determines that the standard deviation σ is less than the threshold (NO in STEP 23), the tilt of the resin coating unit 3 is maintained at a current tilt.

On the other hand, in a case where the control unit 9 determines that the standard deviation σ is equal to or greater than the threshold (YES in STEP 23), the resin coating unit 3 is tilted (STEP 24). For example, the control unit 9 outputs a control signal to a drive mechanism (not shown) that controls the tilt of the resin coating unit 3. The resin coating unit 3 is tilted in a given direction by the drive mechanism. Then, the process returns to STEP 21, and STEP 21 to STEP 24 are repeated until it is determined that the standard deviation σ is equal to or greater than the threshold.

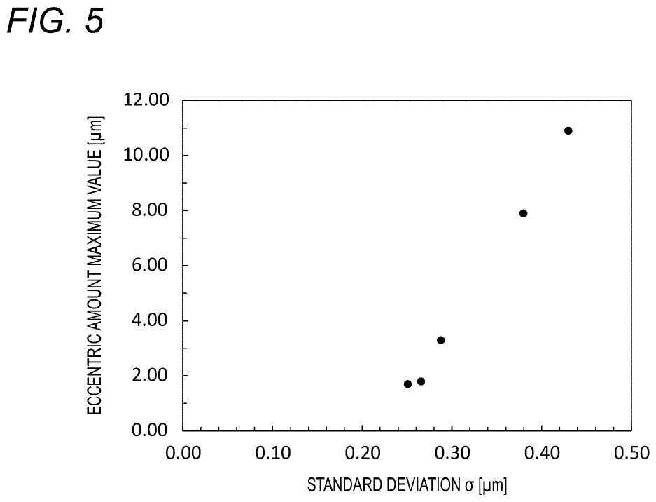

Table 1 shows the standard deviation σ and an eccentric amount maximum value in a case where the tilt of the resin coating unit 3 is changed in the optical fiber manufacturing apparatus 1. FIG. 5 shows a relationship between the standard deviation σ and the eccentric amount maximum value. In Table 1, θx[°] indicates an angle at which the resin coating unit 3 is tilted from a Z direction toward an X direction, assuming that the traveling direction of the optical fiber G2 is set as the Z direction as shown in FIG. 1. θy[°] indicates an angle at which the resin coating unit 3 is tilted from the Z direction toward a Y direction (a direction perpendicular to a paper surface of FIG. 1). An outer diameter maximum value and an outer diameter minimum value are a maximum value and a minimum value among the measurement values at 750 points obtained by measuring the outer diameter of the optical fiber G2 being manufactured every 20 ms for a total of 15 seconds. The standard deviation σ is a value calculated based on the measurement values at 750 points for the outer diameter of the optical fiber G2 being manufactured. The eccentric amount maximum value is a maximum value among eccentric amounts at 10,000 points measured every 10 mm over 100 m of the manufactured optical fiber G2. The eccentric amount is a value calculated based on images obtained by capturing images of the manufactured optical fiber G2 from two directions perpendicular to the longitudinal direction with cameras.

TABLE 1

| | | | Outer | Outer | | |
|---|---|---|---|---|---|---|
| | | | diameter | diameter | | Eccentric |
| | | | maximum | minimum | Standard | amount |
| | | | value | value | deviation | maximum |
| No. | θx[°] | θy[°] | [μm] | [μm] | σ | value[μm] |
| 1 | 0 | 0 | 172.6 | 170.9 | 0.25 | 1.69 |
| 2 | 0.09 | 0.09 | 171.9 | 170.3 | 0.27 | 1.79 |
| 3 | −0.09 | −0.09 | 171.9 | 170.3 | 0.29 | 3.28 |
| 4 | 0.18 | 0.18 | 171.8 | 169.3 | 0.43 | 10.89 |
| 5 | −0.18 | −0.18 | 171.6 | 169.5 | 0.38 | 7.89 |

From Table 1 and the relationship between the standard deviation σ and the eccentric amount maximum value in FIG. 5, it was found that the standard deviation σ of the outer diameter of the optical fiber G2 and the eccentricity of the coating correlate with each other, specifically, the eccentric amount increases as the standard deviation σ increases. From the tilt of the resin coating unit 3 and the relationship between the standard deviation σ and the eccentric amount maximum value, it was found that in a case where the tilt of the resin coating unit 3 is changed, the standard deviation σ changes, that is, the eccentric amount changes. That is, the present inventors have found that the standard deviation σ changes in a case where the tilt of the resin coating unit 3 is changed, and the eccentricity of the coating of the optical fiber G2 may be adjusted.

Based on this finding, in the method for manufacturing the optical fiber G2 of the present embodiment, the tilt of the resin coating unit 3 is changed based on the standard deviation σ. Accordingly, the eccentricity of the coating may be adjusted according to the state of eccentricity of the coating regardless of the thickness of the coating. Therefore, even in a case where the coating of the optical fiber G2 is thin, the eccentricity of the coating may be adjusted based on the state of eccentricity of the coating with respect to the glass fiber G1.

In addition, in the present embodiment, since the standard deviation σ is compared with the threshold, the eccentric state of the coating may be easily determined. In addition, since the resin coating unit 3 is tilted in a case where the standard deviation σ is equal to or greater than the threshold, in a case where the eccentricity exceeds the allowable range, the eccentricity may be adjusted so as to decrease the eccentricity. The threshold is appropriately set according to individual differences of the optical fiber manufacturing apparatus 1 (in particular, the resin coating unit 3). For example, in the optical fiber manufacturing apparatus 1 having characteristics shown in Table 1, the optical fiber G2 having eccentricity of 4 μm or less may be manufactured by setting the threshold to 0.3 μm.

In the present embodiment, in a case where the processing from STEP 21 to STEP 24 is repeated, a tilt direction of the resin coating unit 3 in STEP 24 may be determined based on a comparison between a standard deviation before the tilt and a standard deviation after the tilt.

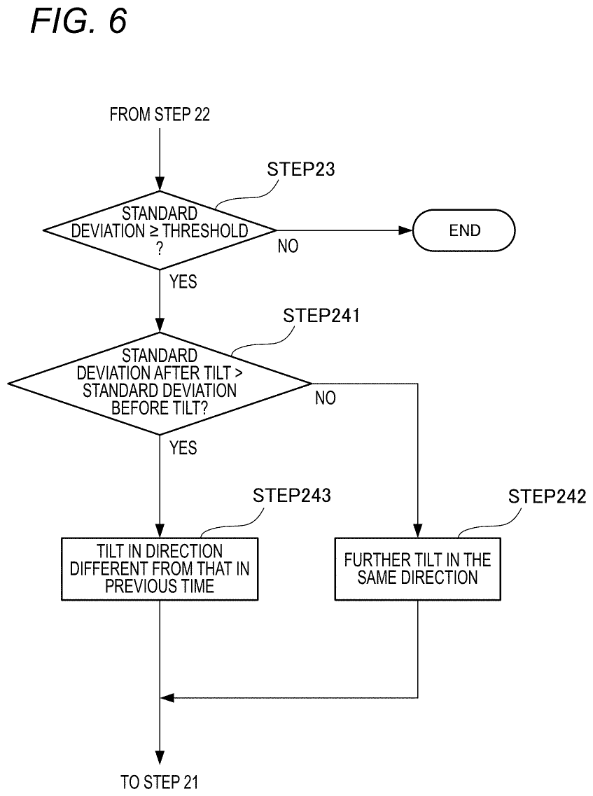

FIG. 6 illustrates a flow of processing performed in STEP 24 in a case where the processing from STEP 21 to STEP 24 in FIG. 4 is repeated. In a case where it is determined in STEP 23 of FIG. 4 that a standard deviation σ calculated based on a plurality of measurement values for the outer diameter of the optical fiber G2 measured after the resin coating unit 3 is tilted is equal to or greater than the threshold, in STEP 241 of FIG. 6, the control unit 9 determines whether the standard deviation σ calculated based on the plurality of measurement values for the outer diameter of the optical fiber G2 measured after the resin coating unit 3 is tilted is greater than a standard deviation σ calculated based on a plurality of measurement values for the outer diameter of the optical fiber G2 measured before the resin coating unit 3 is tilted (STEP 241).

In a case where the control unit 9 determines that the standard deviation σ calculated based on the plurality of measurement values for the outer diameter of the optical fiber G2 measured after the resin coating unit 3 is tilted is equal to or smaller than the standard deviation σ calculated based on the plurality of measurement values for the outer diameter of the optical fiber G2 measured before the resin coating unit 3 is tilted (NO in STEP 241), the resin coating unit 3 is further tilted in the same direction as a previous time (STEP 242).

On the other hand, in a case where the control unit 9 determines that the standard deviation σ calculated based on the plurality of measurement values for the outer diameter of the optical fiber G2 measured after the resin coating unit 3 is tilted is larger than the standard deviation σ calculated based on the plurality of measurement values for the outer diameter of the optical fiber G2 measured before the resin coating unit 3 is tilted (YES in STEP 241), the resin coating unit 3 is tilted in a direction different from that in the previous time (STEP 243).

A direction in which the standard deviation σ, that is, the eccentricity is reduced is found by tilting the resin coating unit 3 in this manner, and the eccentricity may be reduced by tilting the resin coating unit 3 by an appropriate amount in that direction.

In the present embodiment, the direction in which the resin coating unit 3 is tilted is not limited to both the X direction and the Y direction. For example, the direction in which the resin coating unit 3 is tilted may be any one of the X direction or the Y direction. In addition, as the example in which the resin coating unit 3 is tilted in a direction different from that in the previous time, an example in which the resin coating unit 3 is tilted in an opposite direction with respect to the direction of the previous tilt is described. However, for example, assuming that the direction in the previous tilt is the X direction, the resin coating unit 3 may be tilted in the Y direction orthogonal to the X direction.

In addition, in the present embodiment, when the processing from STEP 21 to STEP 24 is repeated, the standard deviation σ is obtained based on the measurement values for the outer diameter measured after the resin coating unit 3 is tilted. However, for example, the standard deviation σ may be calculated based on a plurality of measurement values including measurement values measured before the resin coating unit 3 is tilted and measurement values measured after the resin coating unit 3 is tilted. Also, a standard deviation after the resin coating unit is tilted and a standard deviation before the resin coating unit is tilted may be compared.

Further, in the present embodiment, the resin coating unit 3 is tilted based on the comparison between the standard deviation σ and the threshold. However, instead of comparing the standard deviation σ with the threshold, the tilt of the resin coating unit 3 may be controlled by comparing a plurality of standard deviations σ calculated based on measurement values measured in different periods.

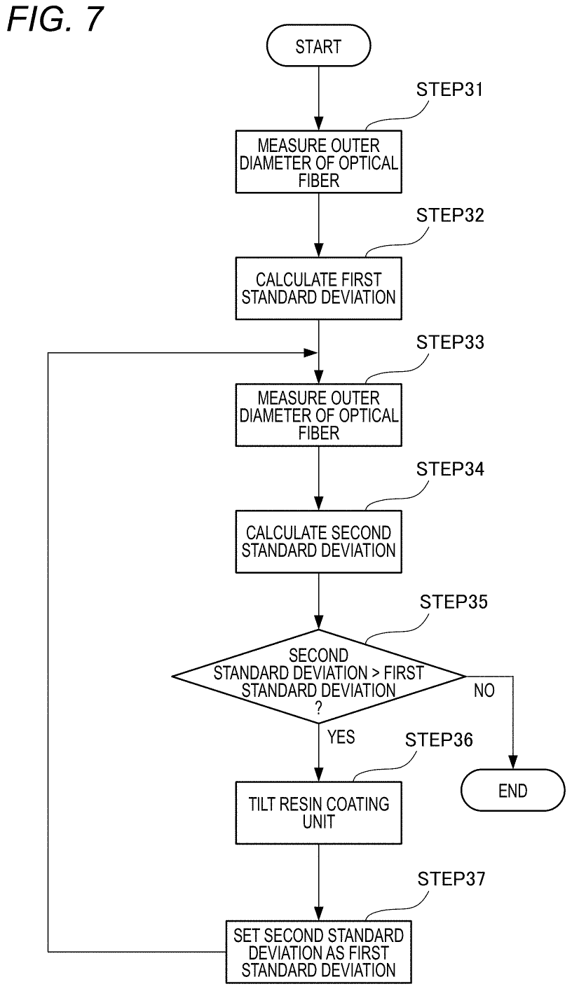

FIG. 7 shows another example of the flow of the method for manufacturing the optical fiber G2. Detailed descriptions of the same steps as those of the eccentric state determining method of FIG. 3 will be omitted.

First, the resin coating is cured by the resin curing unit 4, and the outer diameter of the optical fiber G2 traveling downstream from the resin curing unit 4 is measured a plurality of times by the outer diameter measurement unit 8 in the first period T1 (STEP 31). Then, the control unit 9 calculates the first standard deviation σ1 based on the plurality of measurement values for the outer diameter of the optical fiber G2 measured in the first period T1 (STEP 32).

Subsequently, the outer diameter of the optical fiber G2 is measured by the outer diameter measurement unit 8 a plurality of times in the second period T2 after the first period T1 has elapsed (STEP 33). Then, the control unit 9 calculates the second standard deviation σ2 based on the plurality of measurement values for the outer diameter of the optical fiber G2 measured in the second period T2 (STEP 34).

Subsequently, the control unit 9 controls the tilt of the resin coating unit 3 based on the comparison between the first standard deviation σ1 and the second standard deviation σ2. Specifically, the control unit 9 determines whether the second standard deviation σ2 is larger than the first standard deviation σ1 (STEP 35).

In a case where the control unit 9 determines that the second standard deviation σ2 is equal to or smaller than the first standard deviation σ1 (NO in STEP 35), the tilt of the resin coating unit 3 is maintained at a current tilt.

On the other hand, in a case where the control unit 9 determines that the second standard deviation σ2 is larger than the first standard deviation σ1 (YES in STEP 35), the resin coating unit 3 is tilted (STEP 36). For example, the control unit 9 outputs a control signal to the drive mechanism that controls the tilt of the resin coating unit 3. The resin coating unit 3 is tilted in a given direction by the drive mechanism.

Then, the control unit 9 rewrites a value of the first standard deviation σ1 with a value of the second standard deviation σ2 (STEP 37), then, the process returns to STEP 33, and STEP 33 to STEP 37 are repeated until it is determined that the second standard deviation σ2 measured in a next period is equal to or smaller than the first standard deviation σ1 rewritten in STEP 37.

According to such a method for manufacturing the optical fiber G2, the eccentricity may be adjusted by tilting the resin coating unit 3 by comparing the two standard deviations σ1 and σ2 instead of comparing the standard deviation σ with the threshold. In addition, since the resin coating unit 3 is tilted based on the increase in standard deviation (σ2>σ1), in a case where the standard deviation increases, the eccentricity may be adjusted so as to decrease the eccentricity.

In the present embodiment, the second standard deviation σ2 is calculated based on a plurality of measurement values measured in the second period T2 that starts after the first period T1 has elapsed. However, the second standard deviation σ2 may be calculated based on a plurality of measurement values measured in the second period T2 that starts during the first period T1 after the start of the first period T1. That is, the measurement values used for the second standard deviation σ2 may partially overlap the measurement values used for the first standard deviation σ1.

In addition, in the present embodiment, in a case where the processing from STEP 33 to STEP 37 is repeated, the tilt direction of the resin coating unit 3 in STEP 36 may be determined based on a comparison between a difference between the second standard deviation σ2 and the first standard deviation σ1 before the tilt and a difference between the second standard deviation σ2 and the first standard deviation σ1 after the tilt.

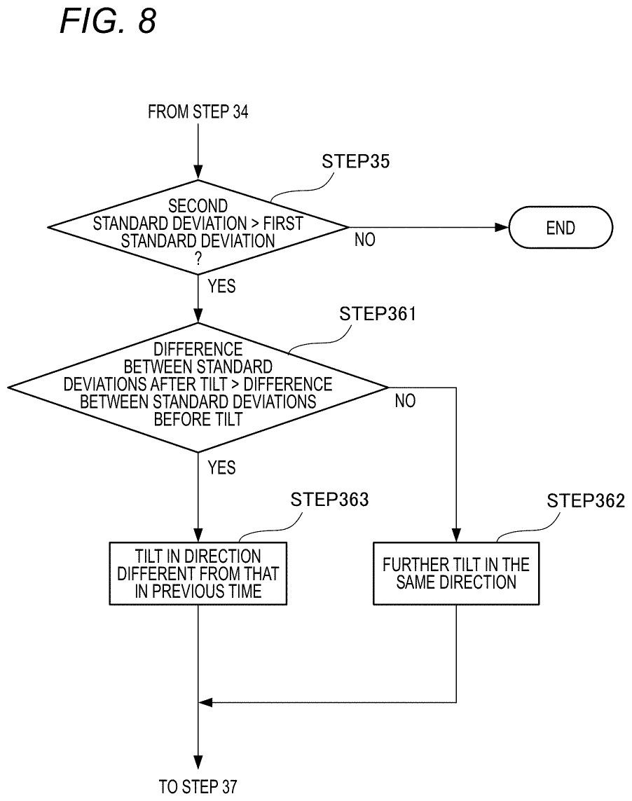

FIG. 8 illustrates a flow of processing performed in STEP 36 in a case where the processing from STEP 33 to STEP 37 is repeated. In a case where it is determined in STEP 35 of FIG. 7 that the second standard deviation σ2 calculated after the resin coating unit 3 is tilted is larger than the first standard deviation σ1, in STEP 361 of FIG. 6, the control unit 9 determines whether a difference between the second standard deviation σ2 and the first standard deviation σ1 that are calculated after the resin coating unit 3 is tilted is larger than a difference between the second standard deviation σ2 and the first standard deviation σ1 that are calculated before the resin coating unit 3 is tilted (STEP 361).

In a case where the control unit 9 determines that the difference between the second standard deviation σ2 and the first standard deviation σ1 calculated after the resin coating unit 3 is tilted is equal to or smaller than the difference between the second standard deviation σ2 and the first standard deviation σ1 calculated before the resin coating unit 3 is tilted (NO in STEP 361), the resin coating unit 3 is further tilted in the same direction as the previous time (STEP 362).

On the other hand, in a case where the control unit 9 determines that the difference between the second standard deviation σ2 and the first standard deviation σ1 calculated after the resin coating unit 3 is tilted is larger than the difference between the second standard deviation σ2 and the first standard deviation σ1 calculated before the resin coating unit 3 is tilted (YES in STEP 361), the resin coating unit 3 is tilted in a direction different from that in the previous time (STEP 363).

The eccentricity may be adjusted so as to decrease the eccentricity by changing the tilt direction of the resin coating unit 3 in a case where the difference between the second standard deviation σ2 and the first standard deviation σ1 increases due to the tilt of the resin coating unit 3.

Although the present disclosure is described in detail with reference to a specific embodiment, it will be apparent to those skilled in the art that various changes and modifications may be made without departing from the spirit and scope of the present disclosure. The numbers, positions, shapes and the like of components described above are not limited to the above embodiment and may be changed to suitable numbers, positions, shapes and the like on a premise that the present disclosure is carried out.

In the above-described embodiment, a case in which, as the method for determining the eccentric state of the optical fiber G2, the state of the eccentricity of the coating is determined by calculating the standard deviation based on the measurement values for the outer diameter of the optical fiber G2 measured during the manufacture of the optical fiber G2 has been described. However, the state of eccentricity of the coating may be determined based on the standard deviation calculated based on the measurement values for the outer diameter of the optical fiber G2 measured after the optical fiber G2 is manufactured. For example, after the winding drum 7 is detached from the manufacturing apparatus, the optical fiber G2 may be taken out from the winding drum, and the measurement values for the outer diameter of the optical fiber G2 may be acquired at a plurality of positions along the longitudinal direction of the optical fiber G2. Then, the standard deviation σ may be calculated based on the plurality of acquired measurement values, and the state of eccentricity of the coating may be determined based on the standard deviation σ.

In the above-described embodiment, the calculation of the standard deviation and the determination of the state of eccentricity are performed by the single control unit 9, but may be performed by different control units.

The optical fiber manufacturing apparatus 1 is not limited to the configuration illustrated in FIG. 1. For example, in the optical fiber manufacturing apparatus 1, a cooling device may be provided between the heating furnace 2 and the resin coating unit 3.

An object of the present disclosure is to determine a state of eccentricity of a coating with respect to a glass fiber even in a case where the coating of the optical fiber is thin.

What is claimed is:

1. An eccentric state determining method which is performed by a controller and for determining a state of eccentricity of a coating of a glass fiber with respect to the glass fiber, the coating being formed around the glass fiber, the method comprising:
acquiring measurement values for an outer diameter of the optical fiber at positions along a longitudinal direction of the optical fiber;
calculating a standard deviation of the measurement values; and
determining the state of the eccentricity based on the standard deviation.

2. The eccentric state determining method according to claim 1, wherein
in the determining, the controller determines that the eccentricity exceed an allowable range in a case where the standard deviation is equal to or greater than a threshold.

3. The eccentric state determining method according to claim 1, wherein
the measurement values are measured with given time interval during manufacture of the optical fiber,
the standard deviation includes a first standard deviation calculated from the measurement values measured in a first period, and a second standard deviation calculated from the measurement values measured in a second period after the first period, and
in the determination step, the state of the eccentricity is determined based on a comparison between the first standard deviation and the second standard deviation.

4. The eccentric state determining method according to claim 3, wherein
in the determination step, the controller determines that the eccentricity increases in a case where the second standard deviation is larger than the first standard deviation.

5. An optical fiber manufacturing method for manufacturing an optical fiber by forming a glass fiber by heating and melting an optical fiber preform and drawing the optical fiber preform, and forming a coating around the glass fiber with a resin coating unit, the method comprising:
measuring an outer diameter of the optical fiber at given time intervals during the manufacturing of the optical fiber to acquire measurement values for the outer diameter;
calculating a standard deviation of the measurement values; and
tilting the resin coating unit based on the standard deviation.

6. The optical fiber manufacturing method according to claim 5, wherein
in the tilting, the resin coating unit is tilted in a case where the standard deviation is equal to or greater than a threshold.

7. The optical fiber manufacturing method according to claim 5, wherein
the standard deviation includes a first standard deviation calculated from the measurement values measured in a first period, and a second standard deviation calculated from the measurement values measured in a second period after the first period, and
in the tilting, the resin coating unit is tilted in a case where the second standard deviation is larger than the first standard deviation.

8. The optical fiber manufacturing method according to claim 5, wherein
in the tilting, in a case where a standard deviation calculated from the measurement values including at least one measurement value measured after the resin coating unit is tilted is larger than a standard deviation calculated from the measurement values measured before the resin coating unit is tilted, the resin coating unit is tilted in a direction different from a direction of a previous tilt.

9. The optical fiber manufacturing method according to claim 5, wherein
in the tilting, in a case where a standard deviation after the resin coating unit is tilted is larger than a standard deviation before the resin coating unit is tilted, the resin coating unit is tilted in a direction different from a direction of a previous tilt.

10. The optical fiber manufacturing method according to claim 5, wherein
the standard deviation includes a first standard deviation calculated from the measurement values measured in a first period, and a second standard deviation calculated from the measurement values measured in a second period after the first period,
the second standard deviation is set as the first standard deviation after the tilting, and
in the tilting, in a case where a difference between the first standard deviation and the second standard deviation after the resin coating unit is tilted is larger than a difference between the first standard deviation and the second standard deviation before the resin coating unit is tilted, the resin coating unit is tilted in a direction different from a direction of a previous tilt.
